(19) United States
(12) Patent Application Publication
(10) Pub. No.: US 2024/0210979 A1
(43) Pub. Date: Jun. 27, 2024

(54) DUAL-LOOP LOW DROPOUT REGULATOR AND STABILITY COMPENSATION CIRCUIT AND CONTROL METHOD THEREOF

(71) Applicant: TRITIUM ELECTRONICS PTE. LTD., Singapore (SG)

(72) Inventors: Pao-Cheng CHIU, Hsinchu County (TW); Zhi-Xin CHEN, Hsinchu County (TW)

(21) Appl. No.: 18/536,212

(22) Filed: Dec. 11, 2023

Related U.S. Application Data
(60) Provisional application No. 63/476,634, filed on Dec. 21, 2022.

(30) Foreign Application Priority Data
Apr. 20, 2023 (CN) 202310430819.0

(51) Int. Cl. G05F 1/575; G05F 3/26

(52) U.S. Cl. CPC G05F 1/575; G05F 3/267

(57) ABSTRACT

A dual-loop LDO includes: an output power switch, an outer and inner loop circuit. An output end has a first pole, a control end has a second pole, whereas, an outer loop capacitor of an outer feedback circuit has a third pole. During a case when a load current switches its level, the inner loop circuit adaptively executes swift response, thus shortening a transient response time prior to a time point where output voltage reaches target voltage level. A third pole frequency of the third pole is lower than a first pole frequency of the first pole and a second pole frequency of the second pole to an extent where the dual-loop low dropout regulator approximates a stable state during a normal operation mode and a phase margin of the dual-loop LDO is greater than a preset angle and a bandwidth of the LDO is greater than a preset frequency.

### CROSS REFERENCE

The present invention claims priority to the US provisional patent application Ser. No. 63/476634, filed on Dec. 21, 2022 and claims priority to the CN patent application Ser. No. 202310430819.0, filed on Apr. 20, 2023, all of which foregoing mentioned provisional and nonprovisional patent applications are incorporated herein in their entirety by their reference.

### BACKGROUND OF THE INVENTION

### Field of Invention

The present invention relates to a dual-loop low dropout regulator (LDO); particularly, it relates to such dual-loop LDO having capacity to swiftly respond to an alternation of a load current, thus shortening a transient response time prior to a time point where an output voltage reaches a target voltage level. The present invention also relates to a stability compensation circuit as well as a control method of such dual-loop LDO.

### Description of Related Art

Please refer to FIG. 1, which shows a schematic circuit diagram of a prior art low dropout regulator (LDO) 100. The prior art LDO 100 includes: an output power switch Qout, an output capacitor Cout, a feedback circuit 111 and a gain stage 112. The feedback circuit 111 obtains a divided voltage of an output voltage Vout for providing a feedback signal to the gain stage 112 in a negative feedback fashion. The gain stage 112 serves to amplify a difference between a reference voltage Vref and a feedback signal, so as to regulate the output voltage Vout and serves to provide a load current Iload to a load circuit 10. In the prior art LDO 100, an output end Nout has a first pole P1, wherein the first pole P1 is predominantly generated by the output capacitor Cout as well as an output resistor at the output end Nout. A control end Nctl of the output power switch Qout has a second pole P2, wherein the second pole P2 is predominantly generated by a base-to-ground parasitic capacitor of the output power switch Qout and an output resistor at the base of the output power switch Qout. The gain stage 112 has third pole P3, wherein the third pole P3 is predominantly generated by a gain capacitor Cgn coupled to the gain stage 112 as well as an output resistor of the gain stage 112.

For a commonplace prior art high power LDO, such as the LDO 100 shown in FIG. 1, a bipolar junction transistor (BJT) independent from an integrated circuit (IC) chip where the foregoing gain stage 112 is disposed therein often function as the foregoing output power switch Qout. As a result, in a case where the independent BJT independent from the IC chip where the foregoing gain stage 112 is disposed therein, as shown in FIG. 1, because each of the first pole P1 and the second pole P2 typically has a relatively greater time constant and because the first pole P1 is quite close to the second pole P2 in a typical Bode plot (not shown), for the sake of maintaining as system stability of the prior art high power LDO 100, it is required for the third pole P3 (i.e., a major pole) to carry a relatively much greater time constant (as compared to the first pole P1 and the second pole P2) to ensure system stability. The first pole P1 is correlated with the demands for the load circuit 10, wherein the demands for the load circuit 10 will decide a size of the output capacitor Cout. Generally speaking, as compared to a typical non-high power LDO, because the load current Iload flowing through the load circuit 10 driven by the prior art high power LDO 100 is relatively much greater (i.e., a level of the load current Iload can reach above several hundreds of milliampere), the output capacitor Cout in the prior art high power LDO 100 has a relatively greater size and the first pole P1 has a relatively greater time constant. The second pole P2 is located at the base of the output power switch Qout. For the sake of taking the demands of the power and the demands of the current into consideration, a resistor Rd has a relatively greater resistance, so second pole P2 has a relatively greater time constant.

For the sake of preserving the stability of the prior art LDO 100, if the third pole P3 (i.e., a major pole) must carry a relatively much greater time constant (as compared to the first pole P1 and the second pole P2), it is required for the IC chip where the foregoing gain stage 112 is disposed therein to provide a relatively much huger area for accommodating a gain capacitor Cgn, so that a scenario where the third pole P3 will have capacity to carry a relatively much greater time constant can be accomplished. The prior art LDO 100 shown in FIG. 1 has following numerous defects that: because it is required for the third pole P3 to carry a relatively much greater time constant, a transient response time of the prior art LDO 100 will be unwantedly prolonged, thus leading to an excessively slow response time for a load circuit 10 and to thereby result in deleterious over-shooting voltage and undershooting voltage. As a result, in this case, operation performance of the prior art LDO 100 will be undesirably reduced, thereby undermining the prior art LDO 100.

In view of the above, to overcome the defects in the prior art shown in FIG. 1, please refer to FIG. 2, which shows a schematic circuit diagram of a prior art dual-loop LDO disclosed in U.S. Publication Patent No. 2020/0225689 A1. As shown in FIG. 2, as compared to the prior art LDO 100, the prior art dual-loop LDO 200 further includes an inner loop, wherein the inner loop of the prior art dual-loop LDO 200 serves to expedite a response in a case where a load current (not shown) is abruptly changed. However, the prior art dual-loop LDO 200 shown in FIG. 2 has following numerous defects that: firstly, because the prior art dual-loop LDO 200 remains to execute a same mechanism where a feedback signal is provided to the inner loop via an output voltage Vout, this prior art dual-loop LDO 200 fails to effectively conquer an unwanted defect where major poles in an output stage are too close to each other. Secondly, an outer loop fails to ensure system stability by accomplishing a huge capacitance. Consequently and unfortunately, in this case, this prior art dual-loop LDO 200 is unable to eradicate problem of low stability and excessively long response time for a load.

As compared to the prior arts shown in FIG. 1 and FIG. 2, the present invention is advantageous over the prior arts in that: the present invention proposes a dual-loop LDO and a stability compensation circuit as well as a control method thereof, which is well capable of adaptively feedback-regulating a control voltage based upon the control voltage at a control end of an output power switch, so as to swiftly respond to an alternation of a load current, thus shortening a transient response time prior to time point where the output voltage reaches the target voltage level.

### SUMMARY OF THE INVENTION

From one perspective, the present invention provides a dual-loop low dropout regulator, which is configured to operably convert an input voltage to an output voltage at an output end according to a reference voltage and regulate the thus converted output voltage at a target voltage level, wherein the output end has a first pole; the dual-loop low dropout regulator comprising: an output power switch including: a control end, wherein the control end receives a control voltage to operate the output power switch, so as to generate the output voltage, and wherein the control end has a second pole; an outer loop circuit including: an outer feedback circuit, which is configured to operably generate an outer feedback voltage based upon the output voltage; and a major gain stage, which is configured to operably amplify a difference between the reference voltage and the outer feedback voltage, so as to generate a major gain voltage and hence regulating the output voltage at the target voltage level; wherein the major gain stage has an outer loop capacitor, which is configured to operably provide a third pole; and an inner loop circuit coupled between the major gain stage and the control end, wherein the inner loop circuit includes: an inner feedback circuit, which is configured to operably generate an inner feedback voltage in accordance with the control voltage; and a swift gain stage, which is configured to operably amplify a difference between the major gain voltage and the inner feedback voltage, so as to generate the control voltage at the control end; wherein a third pole frequency of the third pole is lower than a first pole frequency of the first pole and is lower than a second pole frequency of the second pole to an extent where the dual-loop low dropout regulator approximates a stable state during a normal operation mode and to an extent where a phase margin of the dual-loop low dropout regulator is greater than a preset angle and a bandwidth of the dual-loop low dropout regulator is greater than a preset frequency.

From another perspective, the present invention provides a stability compensation circuit of a dual-loop low dropout regulator, which is configured to operably control an output power switch of the dual-loop low dropout regulator, wherein the dual-loop low dropout regulator is configured to operably convert an input voltage to an output voltage at an output end according to a reference voltage and to regulate the thus converted output voltage at a target voltage level, wherein the output end has a first pole; wherein the output power switch includes: a control end, wherein the control end receives a control voltage to operate the output power switch, so as to generate the output voltage, and wherein the control end has a second pole; the stability compensation circuit comprising: an outer loop circuit including: an outer feedback circuit, which is configured to operably generate an outer feedback voltage based upon the output voltage; and a major gain stage, which is configured to operably amplify a difference between the reference voltage and the outer feedback voltage, so as to generate a major gain voltage and hence regulating the output voltage at the target voltage level; wherein the major gain stage has an outer loop capacitor, which is configured to operably provide a third pole; and an inner loop circuit coupled between the major gain stage and the control end, wherein the inner loop circuit includes: an inner feedback circuit, which is configured to operably generate an inner feedback voltage in accordance with the control voltage; and a swift gain stage, which is configured to operably amplify a difference between the major gain voltage and the inner feedback voltage, so as to generate the control voltage at the control end; wherein a third pole frequency of the third pole is lower than a first pole frequency of the first pole and is lower than a second pole frequency of the second pole to an extent where the dual-loop low dropout regulator approximates a stable state during a normal operation mode and to an extent where a phase margin of the dual-loop low dropout regulator is greater than a preset angle and a bandwidth of the dual-loop low dropout regulator is greater than a preset frequency.

From yet another perspective, the present invention provides a control method of a dual-loop low dropout regulator for controlling an output power switch of the dual-loop low dropout regulator to convert an input voltage to an output voltage at an output end according to a reference voltage and to regulate the thus converted output voltage at a target voltage level, wherein the output end has a first pole; wherein the output power switch includes: a control end, wherein the control end receives a control voltage to operate the output power switch, so as to generate the output voltage, and wherein the control end has a second pole; the control method circuit comprising following steps: providing an outer loop circuit, wherein an outer loop circuit control method of the outer loop circuit includes following steps: generating an outer feedback voltage based upon the output voltage; amplifying a difference between the reference voltage and the outer feedback voltage, so as to generate a major gain voltage and hence regulating the output voltage at the target voltage level; and providing a third pole the major gain stage has an outer loop capacitor; and providing an inner loop circuit, wherein an inner loop circuit control method of the inner loop circuit includes following steps: generating an inner feedback voltage in accordance with the control voltage; and amplifying a difference between the major gain voltage and the inner feedback voltage, so as to generate the control voltage at the control end; wherein a third pole frequency of the third pole is lower than a first pole frequency of the first pole and is lower than a second pole frequency of the second pole to an extent where the dual-loop low dropout regulator approximates a stable state during a normal operation mode and to an extent where a phase margin of the dual-loop low dropout regulator is greater than a preset angle and a bandwidth of the dual-loop low dropout regulator is greater than a preset frequency.

In one embodiment, the output power switch includes: a bipolar junction transistor (BJT), an insulated gate bipolar transistor (IGBT) or a lateral diffused MOSFET (LDMOS).

In one embodiment, the output power switch constitutes a source follower or an emitter follower.

In one embodiment, the outer loop circuit as well as the inner loop circuit together constitutes a stability compensation circuit, and wherein the major gain stage, the outer loop capacitor and the swift gain stage are all entirely packaged into an integrated circuit (IC) chip.

In one embodiment, the outer loop capacitor includes: a switched capacitor.

In one embodiment, a gain of the major gain stage is greater than a gain of the swift gain stage.

In one embodiment, the swift gain stage includes: a swift amplifier, which is configured to operably amplify the difference between the major gain voltage and the inner feedback voltage, thus generating a swift amplification voltage; a swift power switch, which is configured to be operably operated via the swift amplification voltage, to generate a swift conductance signal; and a driving power switch, which is configured to operably receive the swift conductance signal, thereby generating the control voltage.

In one embodiment, the outer loop circuit further includes: a major amplifier, which is configured to operably amplify the difference between the reference voltage and the outer feedback voltage, so as to generate a major amplification voltage; a major power switch, which is configured to be operably operated via a filtered voltage, to generate a major conductance signal, wherein the filtered voltage is generated by executing an operation of filtering on the major amplification voltage via the outer loop capacitor; and a conversion circuit, which is configured to operably convert the major conductance signal to the major gain voltage.

In one embodiment, the conversion circuit includes: a current mirror circuit; and the major conductance signal includes: a major conductance current; wherein the current mirror circuit is configured to operably mirror the major conductance current, so that the major conductance current flows through a conversion resistor, thus generating the major gain voltage.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic circuit diagram of a prior art low dropout regulator (LDO).

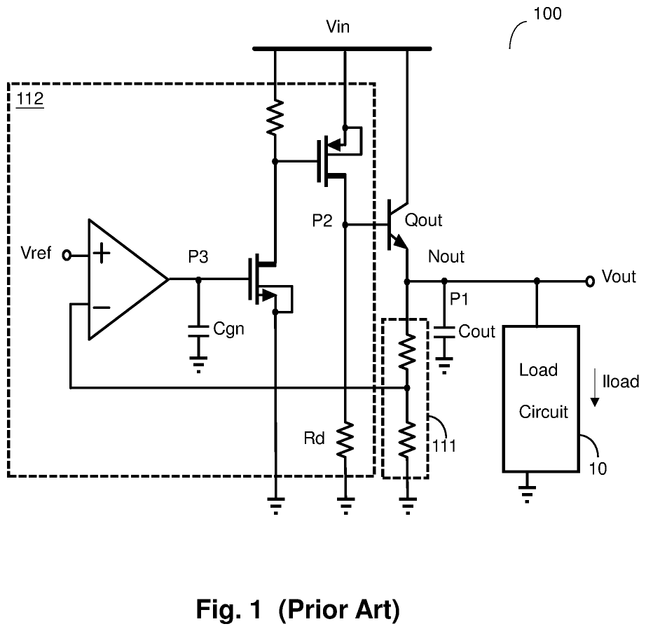

FIG. 2 shows a schematic circuit diagram of a prior art LDO disclosed in U.S. Publication Patent No. 2020/0225689 A1.

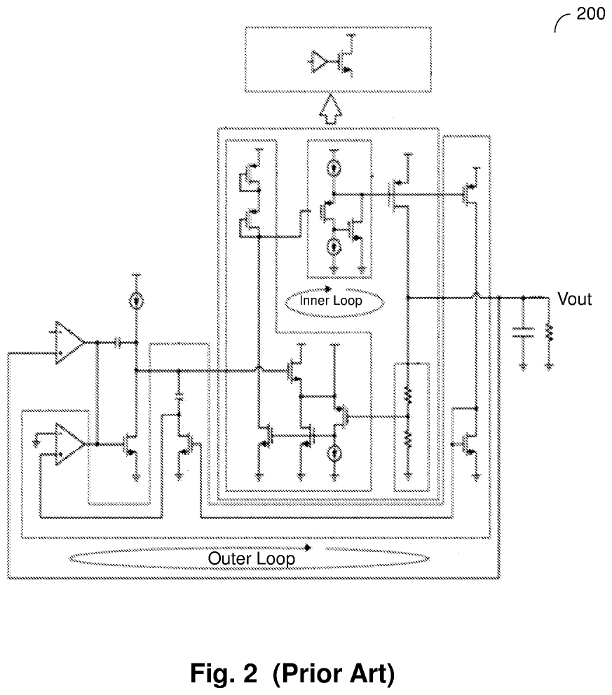

FIG. 3 shows a schematic circuit diagram of a dual-loop LDO 300 according to an exemplary embodiment of the present invention.

FIG. 4 illustrates signal waveform diagrams depicting signals (i.e., a load current Iload and an output voltage Vout) associated with the operation of a dual-loop LDO according to an embodiment of the present invention and the operation of a prior art dual-loop LDO.

FIG. 5 shows a schematic circuit diagram of an outer loop circuit according to a specific exemplary embodiment of the present invention.

FIG. 6 shows a schematic circuit diagram of an inner loop circuit according to a specific exemplary embodiment of the present invention.

FIG. 7 shows a schematic circuit diagram of a dual-loop LDO 300 according to a specific exemplary embodiment of the present invention.

FIG. 8 shows a schematic Bode plot illustrating open-loop frequency response of an outer loop in a dual-loop LDO, depicting a relationship of gain against frequency according to an exemplary embodiment of the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

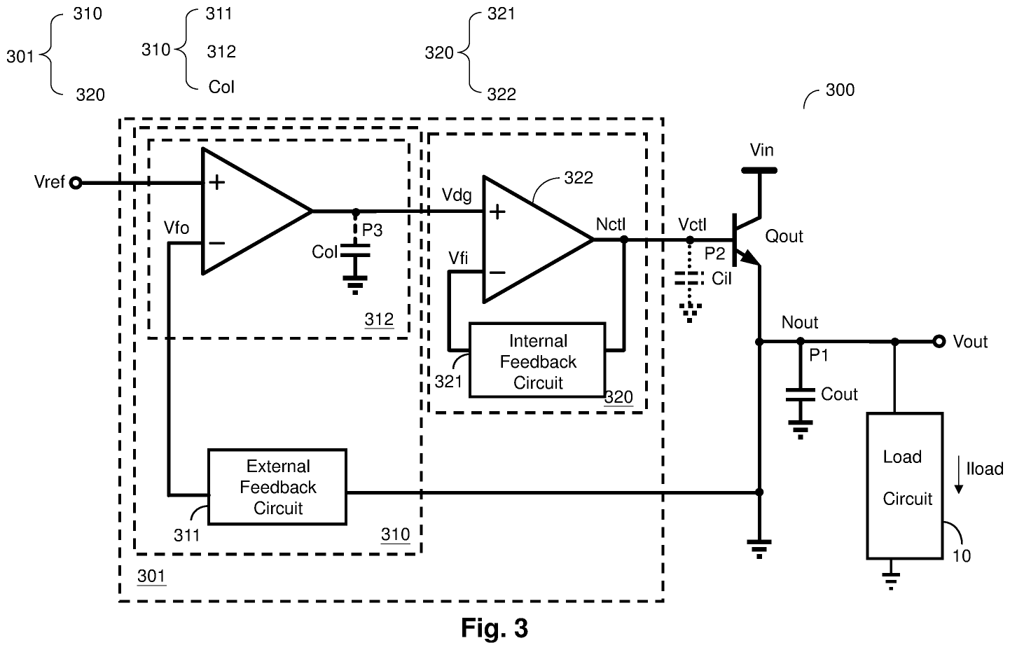

FIG. 3 shows a schematic circuit diagram of a dual-loop LDO 300 according to an exemplary embodiment of the present invention. As shown in FIG. 3, the dual-loop low dropout regulator (LDO) 300 is configured to operably convert an input voltage Vin to an output voltage Vout at an output end Nout according to a reference voltage Vref and regulate the thus converted output voltage Vout at a target voltage level Vtgt, so that the dual-loop LDO 300 provides a load current Iload to a load circuit 10. The dual-loop LDO 300 comprises: an output power switch Qout and a stability compensation circuit 301. The stability compensation circuit 301 includes: an outer loop circuit 310 and an inner loop circuit 320. The aforementioned output end Nout has a first pole P1, wherein the first pole P1 is predominantly generated by an output capacitor Cout as well as an output resistor at the output end Nout.

The output power switch Qout includes: a control end Nctl, wherein the control end Nctl receives a control voltage Vctl to operate the output power switch Qout, so as to generate the output voltage Vout. The control end Nctl has a second pole P2, wherein the second pole P2 is predominantly generated by a base-to-ground parasitic capacitor of the output power switch Qout and an output resistor at the control end Nctl, wherein the base-to-ground parasitic capacitor of the output power switch Qout is illustrated as a dashdotted symbol of a capacitor shown in FIG. 3. The outer loop circuit 310 includes: an outer feedback circuit 311 and a major gain stage 312.

The outer feedback circuit 311 is configured to operably generate an outer feedback voltage Vfo based upon the output voltage Vout. The major gain stage 312 is configured to operably amplify a difference between the reference voltage Vref and the outer feedback voltage Vfo, so as to generate a major gain voltage Vdg and hence regulating the output voltage Vout at the target voltage level Vtgt.The major gain stage 312 has an outer loop capacitor Col, wherein the outer loop capacitor Col is configured to operably provide a third pole P3.

The inner loop circuit 320 includes: an inner feedback circuit 321 and a swift gain stage 322. The inner feedback circuit 321 is configured to operably generate an inner feedback voltage Vfi in accordance with the control voltage Vctl. The swift gain stage is configured to operably amplify a difference between the major gain voltage Vdg and the inner feedback voltage Vfi, so as to generate the control voltage Vctl at the control end Nctl.

A third pole frequency fr3 of the third pole P3 is lower than a first pole frequency fr1 of the first pole P1 and is lower than a second pole frequency fr2 of the second pole P2 to an extent where the dual-loop LDO 300 approximates a stable state (i.e., the dual-loop LDO 300 stably operates in a negative feedback control mechanism) during a normal operation mode and to an extent where a phase margin of the dual-loop LDO 300 is greater than a preset angle and a bandwidth of the dual-loop LDO 300 is greater than a preset frequency. In one embodiment, the preset angle is for example but not limited to 45 degrees. That is, phase margin of the dual-loop LDO 300 is greater than 45 degrees. Additionally, during a case where the load current

Iload switches its level, the inner loop circuit 320 adaptively executes swift response, thus shortening a transient response time. Note that, in this embodiment, as one of average skill in the art will further appreciate, the term “transient response time”, as may be used herein, refers to: an interval prior to a duration ranging from a time point where an abrupt level variation of the output voltage Vout in a situation that the load current Iload switches its level to a time point where a level of the output voltage Vout returns to a constant target voltage level Vtgt.

In one embodiment, the output power switch Qout includes: a bipolar junction transistor (BJT), an insulated gate bipolar transistor (IGBT) or a lateral diffused MOSFET (LDMOS). In one embodiment, the output power switch Qout constitutes a source follower or an emitter follower.

In one embodiment, the outer loop circuit 310 as well as the inner loop circuit 320 together constitutes a stability compensation circuit 301. The major gain stage 312, the outer loop capacitor Col and the swift gain stage 322 are all entirely packaged into an integrated circuit (IC) chip. In one embodiment, the outer loop capacitor includes: a switched capacitor. The switched capacitor includes, for example, one or several switches and one or several switchable capacitors. As a result, in this configuration, a capacitance of the outer loop capacitor Col can be augmented through conducting an operation of switching of the switches, so that the outer loop capacitor Col having a relatively greater capacitance and a relatively smaller size can be carried out inside the IC chip

In one embodiment, a gain of the major gain stage 312 is greater than a gain of the swift gain stage 322. The purpose for implementing the major gain stage 312 as having a relatively greater gain lies in that: in a scenario where the load current Iload of the load circuit 10 has different levels, a conversion efficiency of regulating the output voltage Vout will be maintained.

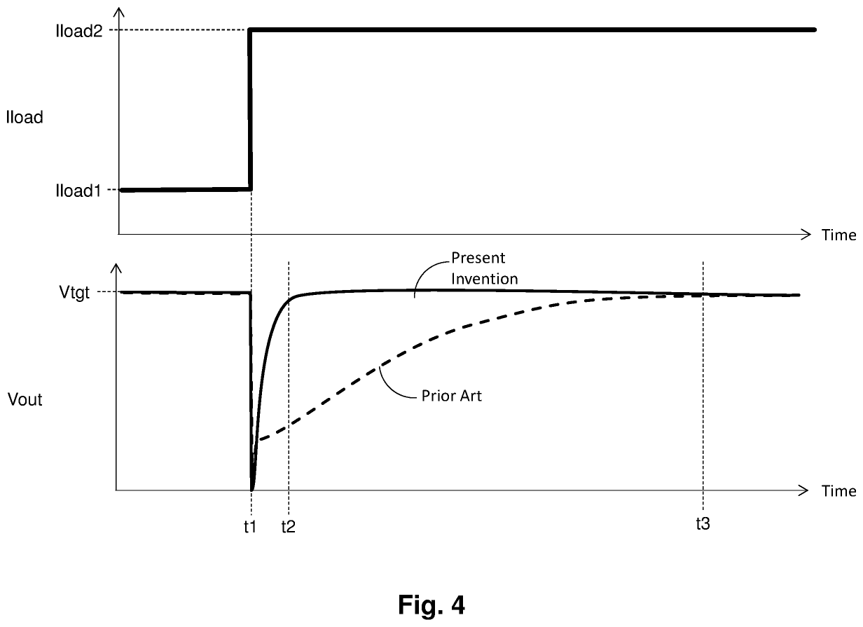

FIG. 4 illustrates signal waveform diagrams depicting signals (i.e., a load current Iload and an output voltage Vout) associated with the operation of a dual-loop LDO according to an embodiment of the present invention and the operation of a prior art dual-loop LDO. On one hand, as shown by a top portion in FIG. 4, when a current level Iload1 of the load current Iload is augmented to a current level Iload2 of the load current Iload at a time pot t1, it indicates that: a required power consumption of the load circuit 10 is enhanced. On the other hand, as shown by a bottom portion in FIG. 4, in a case where the power consumption of the load circuit 10 (no matter in the present invention or in the prior art) is abruptly enhanced at the time pot t1, it will incur a situation where a level of the output voltage Vout is abruptly reduced from the target voltage level Vtgt. Because the dual-loop LDO 300 according to the present invention has the inner loop circuit capable of executing an operation of swift compensation, as compared to the prior art, the inner loop circuit of the present invention has capacity to compensate a level of the control voltage Vctl within an extremely short time to an extent where the level of the control voltage Vctl is returned back to a level prior to variation, thereby regulating the output voltage Vout back to a stable and a constant target voltage level Vtgt. Nevertheless, for a prior art dual-loop LDO, because the prior art dual-loop LDO has no any swift compensation loop or because the prior art dual-loop LDO remains to regulate the output voltage Vout back to the target voltage level Vtgt by executing an operation of a feedback controlling in a case where a divided voltage of the output voltage Vout functions as a feedback signal, as compared to the present invention, it takes an extremely long time for the prior art dual-loop LDO to regulate the output voltage Vout back to a stable and a constant target voltage level Vtgt. As shown by a bottom portion in FIG. 4, if the prior art dual-loop LDO intends to regulate the output voltage Vout to the target voltage level Vtgt, as compared to a time point t2 (where the output voltage Vout is regulated back to a stable and a constant target voltage level Vtgt) in the present invention, it will take an extremely long time for the prior art dual-loop LDO to regulate the output voltage Vout back to a stable and a constant target voltage level Vtgt at a time point t3 (note that the time point t3 is extremely longer than the time point t2).

It is worthwhile noting that: in this embodiment shown in FIG. 3 and the following embodiments hereinafter, “the N-type MOS device, the IGBT device as well as the BJT device” and “the P-type MOS device, the IGBT device as well as the BJT device” are interchangeable, with corresponding amendments of the connection approach and with corresponding attention upon matching relationships among “the MOS devices, the IGBT device as well as the BJT device”, which is well known to those skilled in the art, so the details thereof are not redundantly explained here.

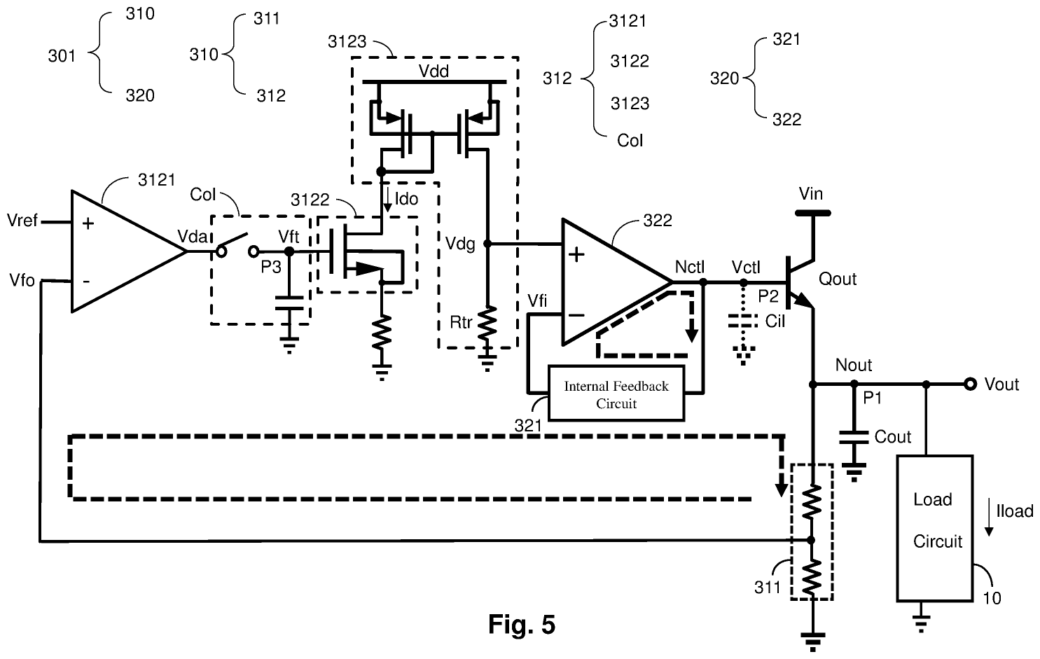

FIG. 5 shows a schematic circuit diagram of an outer loop circuit 310 according to a specific exemplary embodiment of the present invention. As shown in FIG. 5, this embodiment shown in FIG. 5 is similar to the embodiment shown in FIG. 3, but is different in that: this embodiment shown in FIG. 5 shows a schematic circuit diagram of an outer loop circuit 310 according to a specific exemplary embodiment of the present invention. In this embodiment, the outer loop circuit 310 includes: an outer feedback circuit 311 and a major gain stage 312.

As shown in FIG. 5, the outer feedback circuit 311 includes, for example, a voltage-divider circuit coupled to the output end Nout, wherein the voltage-divider circuit serves to execute an operation of voltage-division on the output voltage Vout, so as to generate an outer feedback voltage Vfo which is inputted into the major gain stage 312. The major gain stage 312 includes: a major amplifier 3121, an outer loop capacitor Col, a major power switch 3122 and a conversion circuit 3123. The major amplifier 3121 is configured to operably amplify the difference between the reference voltage Vref and the outer feedback voltage Vfo, so as to generate a major amplification voltage Vda. The major power switch 3122 is configured to be operably operated via a filtered voltage, to generate a major conductance signal, wherein the filtered voltage Vft is generated by executing an operation of filtering on the major amplification voltage Vda via the outer loop capacitor Col. In one embodiment, as shown in FIG. 5, the major conductance signal includes: a major conductance current Ido flowing through the major power switch 3122 in a case where the major power switch 3122 is ON. The conversion circuit 3123 is configured to operably convert the major conductance signal to the major gain voltage Vdg. In one embodiment, as shown in FIG. 5, the conversion circuit 3123 includes: a current mirror circuit, wherein the current mirror circuit is configured to operably mirror the major conductance current Ido, so that the major conductance current flows through a conversion resistor Rtr, thus generating the major gain voltage Vdg. An inner supply voltage Vdd serves to provide power supply to the conversion circuit 3123. In one embodiment, the foregoing inner supply voltage Vdd can be an input voltage Vin.

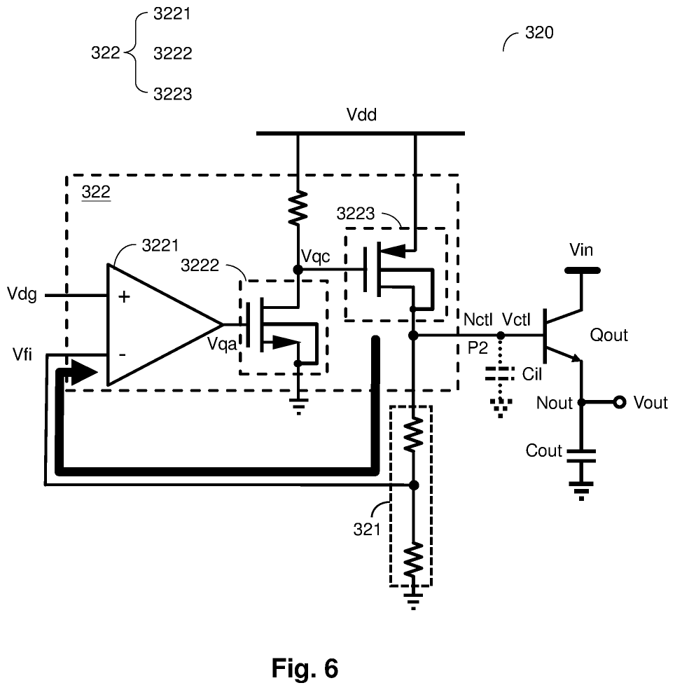

FIG. 6 shows a schematic circuit diagram of an inner loop circuit 320 according to a specific exemplary embodiment of the present invention. As shown in FIG. 6, the inner loop circuit 320 includes: an inner feedback circuit 321 and a swift gain stage 322. The inner feedback circuit 321 includes, for example, a voltage-divider circuit coupled to the control end Nctl, wherein the voltage-divider circuit serves to execute an operation of voltage-division on the control voltage Vctl, so as to generate an inner feedback voltage Vfi which is inputted into the swift gain stage 322. The swift gain stage 322 includes: a swift amplifier 3221, a swift power switch 3222 and a driving power switch 3223. The swift amplifier 3221 is configured to operably amplify the difference between the major gain voltage Vdg and the inner feedback voltage Vfi, thus generating a swift amplification voltage Vqa. The swift power switch 3222 includes, for example but not limited to, an N-type MOS device as shown in FIG. 6, wherein the swift power switch 3222 is configured to be operably operated via the swift amplification voltage Vqa, to generate a swift conductance signal Vqo. The driving power switch 3223 includes, for example but not limited to, a P-type MOS device as shown in FIG. 6, wherein the driving power switch 3223 is configured to operably receive the swift conductance signal Vqc, thereby generating the control voltage Vctl. An inner supply voltage Vdd serves to provide power supply to the swift gain stage 322. In one embodiment, the foregoing inner supply voltage Vdd can be an input voltage Vin.

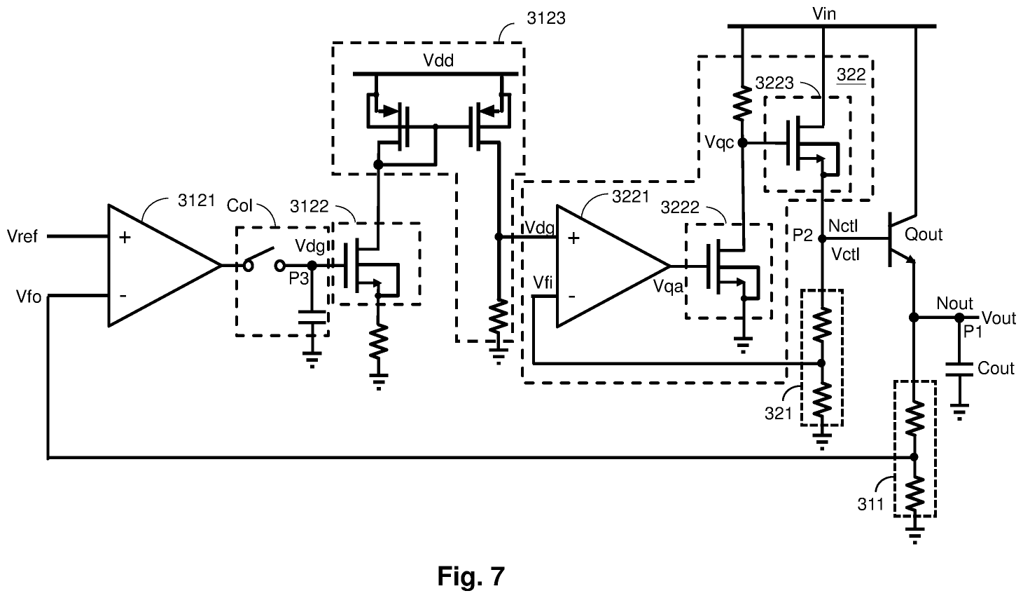

FIG. 7 shows a schematic circuit diagram of a dual-loop LDO 300 according to a specific exemplary embodiment of the present invention. The dual-loop LDO 300 shown in FIG. 7 comprises: an outer loop circuit 310 shown in FIG. 5 and an inner loop circuit 320 shown in FIG. 6. This embodiment of shown in FIG. 7 is meant to elucidate that: the outer loop circuit 310 shown in FIG. 5 and the inner loop circuit 320 shown in FIG. 6 can be combined together in a same implementation of the dual-loop LDO 300 shown in FIG. 7.

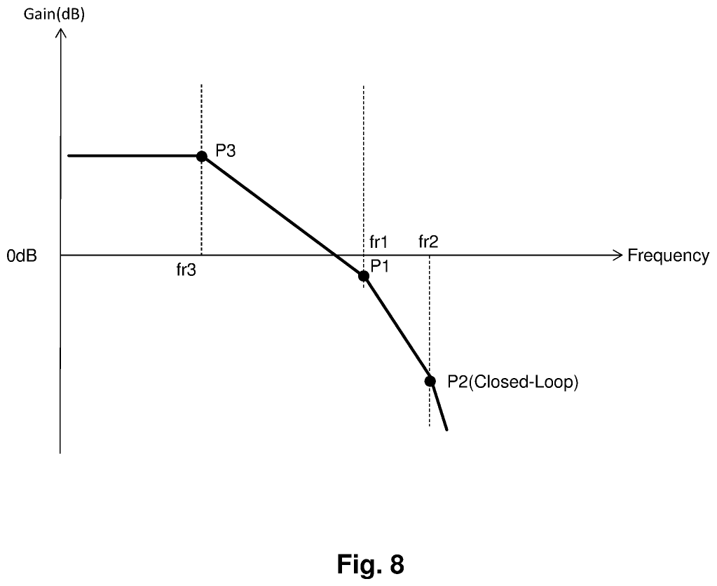

FIG. 8 shows a schematic Bode plot illustrating open-loop frequency response of an outer loop in a dual-loop LDO, depicting a relationship of gain against frequency according to an exemplary embodiment of the present invention. Please refer to FIG. 8 along with FIG. 3. As shown in FIG. 8, as compared to an open-loop of an outer loop constituted by the major gain stage 312, the inner loop circuit 320 and the output power switch Qout, because an inner loop constituted by the inner feedback circuit 321 and the swift gain stage 322 has already been coupled to become a closed-loop which is in a negative feedback state, for the open-loop of an outer loop, a pole position of the inner loop is literally a closed-loop position (i.e., a second pole frequency fr2 corresponding to the second pole P2) which is a position of the second pole P2. As shown in FIG. 8, as compared to the first pole P1 (i.e., the first pole frequency fr1 corresponding to the first pole P1) and the third pole P3 (i.e., third pole frequency fr3 corresponding to the third pole P3) in the open-loop of the outer loop, because the closed-loop position which is the position of the second pole P2 is relatively distant from the position of the first pole P1 and the position of the third pole P3 and because the stability of feedback is not impinged, the present invention adopts the third pole P3 to function as a major pole, whereas, the present invention adopts the first pole P1 to function as a pole posterior to the major pole. Consequently, in this case, because the position of the first pole P1 has already been beneath 0 dB, the dual-loop LDO 300 according to the present invention approximates a stable state during a normal operation mode.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A dual-loop low dropout regulator, which is configured to operably convert an input voltage to an output voltage at an output end according to a reference voltage and regulate the thus converted output voltage at a target voltage level, wherein the output end has a first pole; the dual-loop low dropout regulator comprising:
an output power switch including:
a control end, wherein the control end receives a control voltage to operate the output power switch, so as to generate the output voltage, and wherein the control end has a second pole;
an outer loop circuit including:
an outer feedback circuit, which is configured to operably generate an outer feedback voltage based upon the output voltage; and
a major gain stage, which is configured to operably amplify a difference between the reference voltage and the outer feedback voltage, so as to generate a major gain voltage and hence regulating the output voltage at the target voltage level;
wherein the major gain stage has an outer loop capacitor, which is configured to operably provide a third pole; and
an inner loop circuit coupled between the major gain stage and the control end, wherein the inner loop circuit includes:
an inner feedback circuit, which is configured to operably generate an inner feedback voltage in accordance with the control voltage; and
a swift gain stage, which is configured to operably amplify a difference between the major gain voltage and the inner feedback voltage, so as to generate the control voltage at the control end;
wherein a third pole frequency of the third pole is lower than a first pole frequency of the first pole and is lower than a second pole frequency of the second pole to an extent where the dual-loop low dropout regulator approximates a stable state during a normal operation mode and to an extent where a phase margin of the dual-loop low dropout regulator is greater than a preset angle and a bandwidth of the dual-loop low dropout regulator is greater than a preset frequency.

2. The dual-loop low dropout regulator as claimed in claim 1, wherein the output power switch includes: a bipolar junction transistor (BJT), an insulated gate bipolar transistor (IGBT) or a lateral diffused MOSFET (LDMOS).

3. The dual-loop low dropout regulator as claimed in claim 2, wherein the output power switch constitutes a source follower or an emitter follower.

4. The dual-loop low dropout regulator as claimed in claim 1, wherein the outer loop circuit as well as the inner loop circuit together constitutes a stability compensation circuit, and wherein the major gain stage, the outer loop capacitor and the swift gain stage are all entirely packaged into an integrated circuit (IC) chip.

5. The dual-loop low dropout regulator as claimed in claim 4, wherein the outer loop capacitor includes: a switched capacitor.

6. The dual-loop low dropout regulator as claimed in claim 1, wherein a gain of the major gain stage is greater than a gain of the swift gain stage.

7. The dual-loop low dropout regulator as claimed in claim 1, wherein the swift gain stage includes:
a swift amplifier, which is configured to operably amplify the difference between the major gain voltage and the inner feedback voltage, thus generating a swift amplification voltage;
a swift power switch, which is configured to be operably operated via the swift amplification voltage, to generate a swift conductance signal; and
a driving power switch, which is configured to operably receive the swift conductance signal, thereby generating the control voltage.

8. The dual-loop low dropout regulator as claimed in claim 1, wherein the outer loop circuit further includes:
a major amplifier, which is configured to operably amplify the difference between the reference voltage and the outer feedback voltage, so as to generate a major amplification voltage;
a major power switch, which is configured to be operably operated by a filtered voltage, to generate a major conductance signal, wherein the filtered voltage is generated by executing an operation of filtering on the major amplification voltage by the outer loop capacitor; and
a conversion circuit, which is configured to operably convert the major conductance signal to the major gain voltage.

9. The dual-loop low dropout regulator as claimed in claim 8, wherein:
the conversion circuit includes: a current mirror circuit; and
the major conductance signal includes: a major conductance current;
wherein the current mirror circuit is configured to operably mirror the major conductance current, so that the major conductance current flows through a conversion resistor, thus generating the major gain voltage.

10. A stability compensation circuit of a dual-loop low dropout regulator, which is configured to operably control an output power switch of the dual-loop low dropout regulator, wherein the dual-loop low dropout regulator is configured to operably convert an input voltage to an output voltage at an output end according to a reference voltage and to regulate the thus converted output voltage at a target voltage level, wherein the output end has a first pole; wherein the output power switch includes: a control end, wherein the control end receives a control voltage to operate the output power switch, so as to generate the output voltage, and wherein the control end has a second pole; the stability compensation circuit comprising:
an outer loop circuit including:
an outer feedback circuit, which is configured to operably generate an outer feedback voltage based upon the output voltage; and
a major gain stage, which is configured to operably amplify a difference between the reference voltage and the outer feedback voltage, so as to generate a major gain voltage and hence regulating the output voltage at the target voltage level;
wherein the major gain stage has an outer loop capacitor, which is configured to operably provide a third pole; and
an inner loop circuit coupled between the major gain stage and the control end, wherein the inner loop circuit includes:
an inner feedback circuit, which is configured to operably generate an inner feedback voltage in accordance with the control voltage; and
a swift gain stage, which is configured to operably amplify a difference between the major gain voltage and the inner feedback voltage, so as to generate the control voltage at the control end;
wherein a third pole frequency of the third pole is lower than a first pole frequency of the first pole and is lower than a second pole frequency of the second pole to an extent where the dual-loop low dropout regulator approximates a stable state during a normal operation mode and to an extent where a phase margin of the dual-loop low dropout regulator is greater than a preset angle and a bandwidth of the dual-loop low dropout regulator is greater than a preset frequency.

11. The stability compensation circuit as claimed in claim 10, wherein the output power switch includes: a bipolar junction transistor (BJT), an insulated gate bipolar transistor (IGBT) or a lateral diffused MOSFET (LDMOS).

12. The stability compensation circuit as claimed in claim 11, wherein the output power switch constitutes a source follower or an emitter follower.

13. The stability compensation circuit as claimed in claim 10, wherein the outer loop circuit as well as the inner loop circuit together constitutes a stability compensation circuit, and wherein the major gain stage, the outer loop capacitor and the swift gain stage are all entirely packaged into an integrated circuit (IC) chip.

14. The stability compensation circuit as claimed in claim 13, wherein the outer loop capacitor includes: a switched capacitor.

15. The stability compensation circuit as claimed in claim 10, wherein a gain of the major gain stage is greater than a gain of the swift gain stage.

16. The stability compensation circuit as claimed in claim 10, wherein the swift gain stage includes:
a swift amplifier, which is configured to operably amplify the difference between the major gain voltage and the inner feedback voltage, thus generating a swift amplification voltage;
a swift power switch, which is configured to be operably operated by the swift amplification voltage, to generate a swift conductance signal; and
a driving power switch, which is configured to operably receive the swift conductance signal, thereby generating the control voltage.

17. The stability compensation circuit as claimed in claim 10, wherein the outer loop circuit further includes:
a major amplifier, which is configured to operably amplify the difference between the reference voltage and the outer feedback voltage, so as to generate a major amplification voltage;
a major power switch, which is configured to be operably operated by a filtered voltage, to generate a major conductance signal, wherein the filtered voltage is generated by executing an operation of filtering on the major amplification voltage by the outer loop capacitor; and
a conversion circuit, which is configured to operably convert the major conductance signal to the major gain voltage.

18. The stability compensation circuit as claimed in claim 17, wherein:
the conversion circuit includes: a current mirror circuit; and
the major conductance signal includes: a major conductance current;
wherein the current mirror circuit is configured to operably mirror the major conductance current, so that the major conductance current flows through a conversion resistor, thus generating the major gain voltage.

19. A control method of a dual-loop low dropout regulator for controlling an output power switch of the dual-loop low dropout regulator to convert an input voltage to an output voltage at an output end according to a reference voltage and to regulate the thus converted output voltage at a target voltage level, wherein the output end has a first pole; wherein the output power switch includes: a control end, wherein the control end receives a control voltage to operate the output power switch, so as to generate the output voltage, and wherein the control end has a second pole; the control method circuit comprising following steps:
providing an outer loop circuit, wherein an outer loop circuit control method of the outer loop circuit includes following steps:
generating an outer feedback voltage based upon the output voltage;
amplifying a difference between the reference voltage and the outer feedback voltage, so as to generate a major gain voltage and hence regulating the output voltage at the target voltage level; and
providing a third pole the major gain stage has an outer loop capacitor; and
providing an inner loop circuit, wherein an inner loop circuit control method of the inner loop circuit includes following steps:
generating an inner feedback voltage in accordance with the control voltage; and
amplifying a difference between the major gain voltage and the inner feedback voltage, so as to generate the control voltage at the control end;
wherein a third pole frequency of the third pole is lower than a first pole frequency of the first pole and is lower than a second pole frequency of the second pole to an extent where the dual-loop low dropout regulator approximates a stable state during a normal operation mode and to an extent where a phase margin of the dual-loop low dropout regulator is greater than a preset angle and a bandwidth of the dual-loop low dropout regulator is greater than a preset frequency.

20. The control method as claimed in claim 19, wherein the output power switch includes: a bipolar junction transistor (BJT), an insulated gate bipolar transistor (IGBT) or a lateral diffused MOSFET (LDMOS).

21. The control method as claimed in claim 20, wherein the output power switch constitutes a source follower or an emitter follower.

22. The control method as claimed in claim 19, wherein the outer loop circuit as well as the inner loop circuit together constitutes a stability compensation circuit, and wherein the major gain stage, the outer loop capacitor and the swift gain stage are all entirely packaged into an integrated circuit (IC) chip.

23. The control method as claimed in claim 22, wherein the outer loop capacitor includes: a switched capacitor.

24. The control method as claimed in claim 19, wherein a gain of the major gain stage is greater than a gain of the swift gain stage.

25. The control method as claimed in claim 19, wherein the inner loop circuit control method of the inner loop circuit includes following steps:
amplifying the difference between the major gain voltage and the inner feedback voltage, thus generating a swift amplification voltage;
operating a swift power switch via the swift amplification voltage, to generate a swift conductance signal; and
receiving the swift conductance signal, thereby generating the control voltage.

26. The control method as claimed in claim 19, wherein the outer loop circuit control method of the outer loop circuit includes following steps:
amplifying the difference between the reference voltage and the outer feedback voltage, so as to generate a major amplification voltage;
operating a major power switch via a filtered voltage, to generate a major conductance signal, wherein the filtered voltage is generated by executing an operation of filtering on the major amplification voltage via the outer loop capacitor; and
converting the major conductance signal to the major gain voltage.

27. The control method as claimed in claim 26, wherein:
the major conductance signal includes: a major conductance current; and
the step of converting the major conductance signal to the major gain voltage includes following steps:
mirroring the major conductance current, so that the major conductance current flows through a conversion resistor, thus generating the major gain voltage.
